(19) United States
(12) Patent Application Publication
(10) Pub. No.: US 2023/0330879 A1
(43) Pub. Date: Oct. 19, 2023

(54) SHAVING DEVICE POWERED BY VACUUM CLEANER

(71) Applicant: Maother(suzhou) home appliance technology co, ltd., Suzhou (CN)

(72) Inventor: Yi Li, Suzhou (CN)

(21) Appl. No.: 17/659,173

(22) Filed: Apr. 13, 2022

(51) Int. Cl. B26B 21/52; A47L 7/00; B26B 21/40

(52) U.S. Cl. CPC B26B 21/521; A47L 7/0066; A47L 7/009; B26B 21/4037

(57) ABSTRACT

The present disclosure provides a shaving device powered by a vacuum cleaner. The shaving device includes a shaver. The shaver includes a shaver shell, a driving motor, and a shaving blade; the driving motor is mounted in the shaver shell; the shaving blade is located at a front end of the shaver shell; the shaving blade is connected to the driving motor; the shaver shell is provided with an inclined support plate; the inclined support plate supports the shaving blade, and the shaving blade does a reciprocating motion along the inclined support plate. Compared with the existing art, the present disclosure adopts the vacuum cleaner to supply power, which enhances the use experience of a user and improves the hair clipping effect.

### TECHNICAL FIELD

The present disclosure relates to a shaving device, specifically to a shaving device powered by a vacuum cleaner.

### BACKGROUND

A shaving device specifically refers to a device for cutting human surface hairs, pet hair, etc., commonly referred to as a hair clipper, which is mainly composed of a shell, a driving motor, and a shaving blade. The main working principle is to enable, through high-speed rotation of the driving motor and mutual cooperation between an elongated shaft of a rotating shaft and a groove of a shaving blade, teeth of the shaving blade to do a reciprocating motion.

The driving motor of the current shaving device is powered mainly by a battery in the shell or being connected to a commercial power supply, so it needs to be charged or connected to the commercial power supply, and the user experience is poor. There is also a shaving device for pet hairs, which uses an unpowered blade. After the shaving device is connected to a vacuum cleaner, the shaving operation is completed by a suction force input by the vacuum cleaner, but the shaving effect of this kind of shaving device is poor.

### SUMMARY

In view of this, the present disclosure provides a shaving device powered by a vacuum cleaner. The shaving device is powered by the vacuum cleaner, which enhances the use experience of a user and also improves the shaving effect.

To this end, the present disclosure provides a shaving device powered by a vacuum cleaner. The shaving device includes a shaver. The shaver includes a shaver shell, a driving motor, and a shaving blade; the driving motor is mounted in the shaver shell; the shaving blade is located at a front end of the shaver shell; the shaving blade is connected to the driving motor; the shaver shell is provided with an inclined support plate; the inclined support plate supports the shaving blade, and the shaving blade does a reciprocating motion along the inclined support plate; a front end of the shaver shell is communicated to a tail end; the tail end of the shaver shell is connected to one end of a connection pipe through a connector; the other end of the connection pipe is connected to an air inlet of a vacuum cleaner; a negative pressure generated by the vacuum cleaner is released at the front end of the shaver shell through the connection pipe; a power supply of the vacuum cleaner electrifies the connection pipe; and the connection pipe supplies power to the driving motor.

Further, the connector is a plugging pipe, two opposite ends of which are respectively in pluggable connection to the tail end of the shaver shell and the connection pipe.

Further, the above plugging pipe has a connection end; the connection end has a socket; a conductive pin is arranged in the tail end of the shaver shell; and after the connection end is inserted into the tail end of the shaver shell, the conductive pin is electrically connected to the socket.

Further, an outer wall of the connection end is provided with a bulge; and the socket is arranged in the bulge.

Further, the shaver shell is further fixedly connected with an air duct; and the air duct is communicated to the inside of the shaver shell and is communicated with the connection pipe.

Further, the air duct is fixedly connected to an outer wall of the shaver shell; and a first end of the air duct extends to the shaving blade, and an opposite second end extends inwards to an inner cavity of the shaver shell.

Further, the second end of the air duct is communicated to the inner cavity of the shaver shell through a downwards extending ramp; and a V-shaped convex rib is arranged on an inner wall of the ramp.

A shaving device powered by a vacuum cleaner provided by the present disclosure is mainly composed of a shaver shell, a driving motor, and a shaving blade; the driving motor is mounted in the shaver shell; the shaving blade is connected to the driving motor; a tail end of the shaver shell is connected to one end of a connection pipe, and the other end of the connection pipe is connected to an air inlet of the vacuum cleaner; a power supply of the vacuum cleaner electrifies a connection pipe; and the connection pipe supplies power to the driving motor. During working, the power supply of the vacuum cleaner supplies power to the driving motor of the shaving device through the connection pipe, and the driving motor drives teeth of the shaving blade to do a reciprocating motion.

Therefore, compared with the existing art, the present disclosure adopts the vacuum cleaner to supply power, which enhances the use experience of a user and improves the hair clipping effect.

### BRIEF DESCRIPTION OF THE DRAWINGS

By reading the detailed description in the preferred specific implementation modes below, various other advantages and benefits will become clear to those of ordinary skill in the art. The accompanying drawings are only used for the purpose of illustrating the preferred implementation modes, and are not considered as a limitation to the present disclosure. Furthermore, throughout the drawings, the same reference numerals are used to denote the same components. In the drawings:

FIG. 1 is a schematic diagram of an entire structure of a shaving device powered by a vacuum cleaner provided according to an embodiment of the present disclosure.

FIG. 2 is a schematic structural diagram of a shaving device powered by a vacuum cleaner provided according to an embodiment of the present disclosure.

FIG. 3 is a schematic structural diagram of a shaver in a shaving device powered by a vacuum cleaner provided according to an embodiment of the present disclosure.

FIG. 4 is a schematic structural diagram of a plugging pipe in a shaving device powered by a vacuum cleaner provided according to an embodiment of the present disclosure.

### DETAILED DESCRIPTION OF THE EMBODIMENTS

Exemplary embodiments of the present disclosure will be described in more detail below with reference to the accompanying drawings. Although exemplary embodiments of the present disclosure are shown in the drawings, it should be understood that the present disclosure can be implemented in various forms and should not be limited by the embodiments set forth herein. On the contrary, these embodiments are provided to enable a more thorough understanding of the present disclosure and to fully deliver the scope of the present disclosure to those skilled in the art.

### Embodiment I

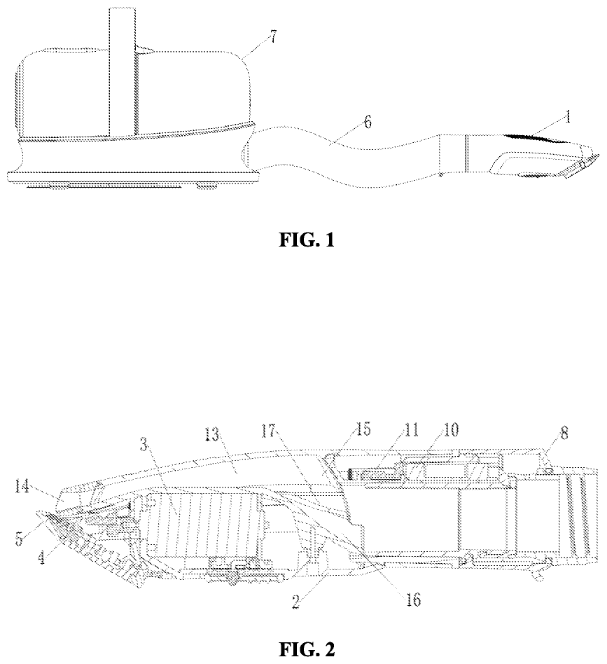

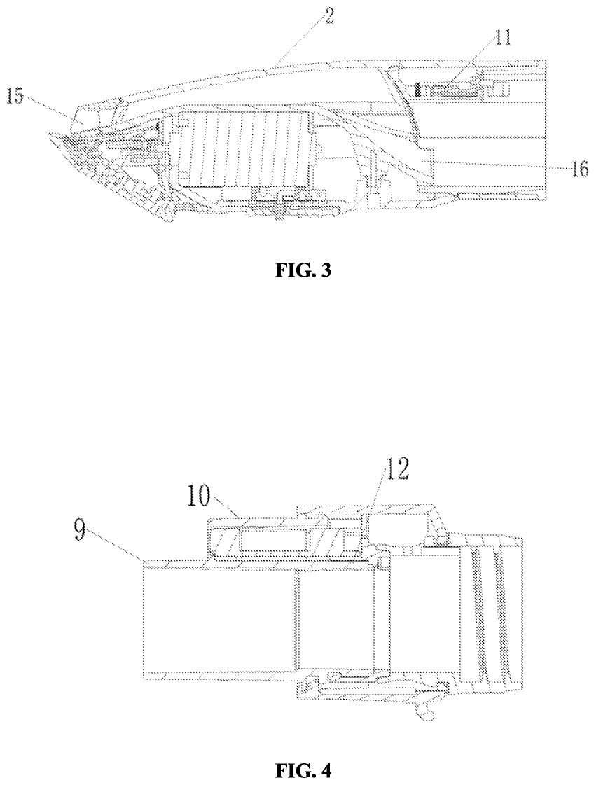

Referring to FIG. 1 to FIG. 4, a shaving device powered by a vacuum cleaner provided according to an embodiment of the present disclosure is illustrated in the figures. The shaving device includes a shaver 1. The shaver 1 includes a shaver shell 2, a driving motor 3, and a shaving blade 4; the driving motor 3 is mounted in the shaver shell 2; the shaving blade 4 is located at a front end of the shaver shell 2; the shaving blade 4 is connected to the driving motor 3; the shaver shell 2 is provided with an inclined support plate 5; the inclined support plate 5 supports the shaving blade 4, and the shaving blade 4 does a reciprocating motion along the inclined support plate 5; a front end of the shaver shell 2 is communicated to a tail end; the tail end of the shaver shell 2 is connected to one end of a connection pipe 6 through a connector; the other end of the connection pipe 6 is connected to an air inlet of a vacuum cleaner 7; a negative pressure generated by the vacuum cleaner 7 is released at the front end of the shaver shell 2 through the connection pipe 6; a power supply of the vacuum cleaner 7 electrifies the connection pipe 6; and the connection pipe 6 supplies power to the driving motor 3.

The shaving device powered by a vacuum cleaner provided by this embodiment is mainly composed of a shaver shell, a driving motor, and a shaving blade; the driving motor is mounted in the shaver shell; the shaving blade is connected to the driving motor; a tail end of the shaver shell is connected to one end of a connection pipe, and the other end of the connection pipe is connected to an air inlet of the vacuum cleaner; a power supply of the vacuum cleaner electrifies a connection pipe; and the connection pipe supplies power to the driving motor. During working, the power supply of the vacuum cleaner supplies power to the driving motor of the shaving device through the connection pipe, and the driving motor drives teeth of the shaving blade to do a reciprocating motion. The inclined support plate has an effect of supporting and guiding the motion of the shaving blade, so that the reciprocating motion of the shaving blade is steady; and at the same time, the negative pressure generated by the vacuum cleaner is released at the front end of the shaver shell through the connection pipe and the connector to suck hairs under the shaving blade at the front end of the shaver shell into the vacuum cleaner.

Therefore, compared with the existing art, this embodiment adopts the vacuum cleaner to supply power, which enhances the use experience of a user and improves the hair clipping effect.

### Embodiment II

Referring to FIG. 1 to FIG. 4, a shaving device powered by a vacuum cleaner provided by Embodiment II of the present disclosure is illustrated in the figures. On the basis of the above embodiment, the following improved technical solution is further made to this embodiment: The connector is a plugging pipe 8, two opposite ends of which are respectively in pluggable connection to the tail end of the shaver shell 2 and the connection pipe 6.

Referring to FIG. 1 to FIG. 4, more specifically, the plugging pipe 8 has a connection end 9; the connection end 9 has a socket 10; a conductive pin 11 is arranged in the tail end of the shaver shell 2; and after the connection end 9 is inserted into the tail end of the shaver shell 2, the conductive pin 11 is electrically connected to the socket 10.

Referring to FIG. 1 to FIG. 4, more specifically, an outer wall of the connection end 9 is provided with a bulge 12; and the socket 10 is arranged in the bulge 12.

By means of the arrangement of the above structure, quick electric connection between the connection pipe and the shaver can be achieved, and removal is more convenient.

### Embodiment III

Referring to FIG. 1 to FIG. 4, a shaving device powered by a vacuum cleaner provided by Embodiment III of the present disclosure is illustrated in the figures. On the basis of the above embodiment, the following improved technical solution is further made to this embodiment: The shaver shell 2 is further fixedly connected with an air duct 13; and the air duct 13 is communicated to the inside of the shaver shell 2 and is communicated with the connection pipe 6.

Referring to FIG. 1 to FIG. 4, specifically, the air duct 13 is fixedly connected to the outer wall of the shaver shell 2.

Referring to FIG. 1 to FIG. 4, more specifically, a first end 14 of the air duct 13 extends to the shaving blade 4, and an opposite second end 15 extends inwards to an inner cavity of the shaver shell 2.

By means of the arrangement of the above structure, a suction function of the vacuum cleaner for hairs can be achieved during shaving, and it is more convenient to clean pet hairs.

### Embodiment IV

Referring to FIG. 1 to FIG. 4, a shaving device powered by a vacuum cleaner provided by Embodiment W of the present disclosure is illustrated in the figures. On the basis of the above embodiment, the following improved technical solution is further made to this embodiment: The second end 15 of the air duct 13 is communicated to the inner cavity of the shaver shell 2 through a downwards extending ramp 16; and a V-shaped convex rib 17 is arranged on an inner wall of the ramp 16. By means of the arrangement of the above structure, due to the ramp, the hair suction speed can be increased; and at the same time, the V-shaped convex rib can press the hairs to prevent the hairs from blocking a passageway.

Obviously, those skilled in the art can make various changes and modifications to the present disclosure without departing from the spirit and scope of the present disclosure. Therefore, if these changes and transformations of the present disclosure fall within the scope of the claims of the present disclosure and equivalent technologies of the present disclosure, the present disclosure is intended to include these changes and transformations.

What is claimed is:

1. A shaving device powered by a vacuum cleaner, wherein the shaving device comprises a shaver (1); the shaver (1) comprises a shaver shell (2), a driving motor (3), and a shaving blade (4); the driving motor (3) is mounted in the shaver shell (2); the shaving blade (4) is located at a front end of the shaver shell (2); the shaving blade (4) is connected to the driving motor (3); the shaver shell (2) is provided with an inclined support plate (5); the inclined support plate (5) supports the shaving blade (4), and the shaving blade (4) does a reciprocating motion along the inclined support plate (5); a front end of the shaver shell (2) is communicated to a tail end; the tail end of the shaver shell (2) is connected to one end of a connection pipe (6) through a connector; the other end of the connection pipe (6) is connected to an air inlet of a vacuum cleaner (7); a negative pressure generated by the vacuum cleaner (7) is released at the front end of the shaver shell (2) through the connection pipe (6); a power supply of the vacuum cleaner (7) electrifies the connection pipe (6); and the connection pipe (6) supplies power to the driving motor (3).

2. The shaving device powered by the vacuum cleaner according to claim 1, wherein the connector is a plugging pipe (8), two opposite ends of which are respectively in pluggable connection to the tail end of the shaver shell (2) and the connection pipe (6).

3. The shaving device powered by the vacuum cleaner according to claim 2, wherein the plugging pipe (8) has a connection end (9); the connection end (9) has a socket (10); a conductive pin (11) is arranged in the tail end of the shaver shell (2); and after the connection end (9) is inserted into the tail end of the shaver shell (2), the conductive pin (11) is electrically connected to the socket (10).

4. The shaving device powered by the vacuum cleaner according to claim 3, wherein an outer wall of the connection end (9) is provided with a bulge (12); and the socket (10) is arranged in the bulge (12).

6. The shaving device powered by the vacuum cleaner according to claim 1, wherein the shaver shell (2) is further fixedly connected with an air duct (13); and the air duct (13) is communicated to the inside of the shaver shell (2) and is communicated with the connection pipe (6).

7. The shaving device powered by the vacuum cleaner according to claim 6, wherein the air duct (13) is fixedly connected to an outer wall of the shaver shell (2); and a first end (14) of the air duct (13) extends to the shaving blade (4), and an opposite second end (15) extends inwards to an inner cavity of the shaver shell (2).

8. The shaving device powered by the vacuum cleaner according to claim 7, wherein the second end (15) of the air duct (13) is communicated to the inner cavity of the shaver shell (2) through a downwards extending ramp (16); and a V-shaped convex rib (17) is arranged on an inner wall of the ramp (16).
